(19) United States
(12) Patent Application Publication
(10) Pub. No.: US 2013/0267035 A1
(43) Pub. Date: Oct. 10, 2013

(54) Isotopic Chemical Analysis using Optical Spectra from Laser Ablation

(71) Applicant: The Regents of the University of California, (US)

(72) Inventors: Richard E. Russo, Walnut Creek, CA (US); Xianglei Mao, Castro Valley, CA (US); Osman Sorkhabi, San Ramon, CA (US); Alexander A. Bol'shakov, Los Altos, CA (US)

(73) Assignee: The Regents of the University of California, Oakland, CA (US)

(21) Appl. No.: 13/835,582

(22) Filed: Mar. 15, 2013

Related U.S. Application Data
(63) Continuation-in-part of application No. PCT/US2011/054994, filed on Oct. 5, 2011.
(60) Provisional application No. 61/390,117, filed on Oct. 5, 2010.

(51) Int. Cl. G01N 21/75

(52) U.S. Cl. CPC G01N 21/75
USPC 436/171

(57) ABSTRACT

This disclosure provides systems, methods, and apparatus related to performing isotopic analysis of a sample. In one aspect a method includes applying laser energy to a region of a sample with a laser to generate a plasma and recording a spectrum generated by a plurality of molecular species in the plasma with a device.

### RELATED APPLICATIONS

This application claims priority to U.S. Provisional Patent Application Ser. No. 61/390,117, filed Oct. 5, 2010, and is a continuation-in-part of International Application No. PCT/US2011/054994, filed Oct. 5, 2011, both of which are herein incorporated by reference.

### STATEMENT OF GOVERNMENT SUPPORT

This invention was made with government support under Contract No. DE-AC02-05CH11231 awarded by the U.S. Department of Energy, under federal Work for Others Awards No. LB09005541 and LB09005541A with the U.S. Department of Defense DTRA (Defense Threat Reduction Agency) under Interagency Cost Reimbursement Orders No. 094711I and 104134I, and under NASA Contract No. NNX10CA07C awarded to Applied Spectra, Inc. The government has certain rights in this invention.

### FIELD

Embodiments disclosed herein related to the field of isotopic chemical analysis.

### BACKGROUND

Isotopic analysis is of interest in archaeology, ecology, nuclear forensics, geology, hydrology, paleoclimatology, and national security. Isotopic analysis is typically done using mass analysis techniques such as GC/MS^{2,3}, TIMS^{4,5}, and ICP-MS techniques⁶⁻¹¹. Mass spectrometry (MS) is a powerful technique for isotopic analysis due to its ability to discriminate based on mass. MS techniques can also be quite sensitive. However, these benefits come at a cost. Nuclear forensics is primarily based on laboratory measurements requiring time consuming counting and/or complex chemical digestion procedures followed by mass spectrometry analysis. Thermo-Ionization mass spectrometry (TIMS) and gamma spectrometry are commonly required for precise isotopic analyses. These measurement technologies require a fairly large amount of sample (milligram to gram range), require sample pre-treatment, and take several days to weeks for sample turn-around. The use of laser ablation with inductively-coupled plasma mass spectrometry (ICP-MS) can eliminate the requirement of sample dissolution, but the sample must be in an Ar or He enclosure. The major drawbacks of MS systems are: (i) the requirement for vacuum, (ii) low throughput, (iii) they cannot detect sample at stand-off distance, and (iv) due to vacuum requirements, such systems tend to be quite bulky.

Other techniques, although less ubiquitous, have also been used for isotopic analysis including ICP-AES⁶⁻⁸, AAS^{12,13}, and GC-AAS¹². Each of these techniques has its own pros and cons. ICP-AES, AAS, and GC-AAS can be very sensitive with sensitivities down to parts per billion (ppb). However, these techniques may require extensive sample preparation and dissolution in a liquid prior to analysis.

### SUMMARY

Embodiments disclosed herein provide apparatus for and methods of performing isotopic analysis on a sample. Methods disclosed herein can measure isotope splitting and isotope abundance ratios in laser plasmas at atmospheric pressure. Methods disclosed herein also can measure the isotope splitting and isotope abundance ratio from molecular species that exist and/or are formed from atoms and ions in the plasma.

One innovative aspect of the subject matter described in this disclosure can be implemented a method including (a) applying laser energy to a region of a sample with a laser to generate a plasma, and (b) recording a spectrum generated by a plurality of molecular species in the plasma with a device. In some embodiments, the sample is in a solid phase, a liquid phase, or a gas phase. In some embodiments, the plurality of molecular species is selected from the group consisting of oxides, nitrides, halides, excimers, diatoms, and combinations thereof.

In some embodiments, the method further includes after operation (a), allowing the plasma to react with species in the surrounding environment to form the plurality of molecular species. In some embodiments, the method further includes after operation (a), allowing species atomized from the sample to react with each other to form the plurality of molecular species.

In some embodiments, operation (a) includes a process selected from the group consisting of ablating the sample with the applied laser energy, vaporizing the sample with the applied laser energy, desorbing the sample with the applied laser energy, and applying the laser energy in a pulse of the laser energy. In some embodiments, operation (a) includes applying a first pulse of laser energy at a first angle with respect to the sample and applying a second pulse of laser energy at a second angle with respect to the first angle.

In some embodiments, operation (b) is selected from the group consisting of recording the spectrum with visible spectroscopy, recording the spectrum with ultraviolet spectroscopy, recording the spectrum with infrared spectroscopy, recording the spectrum with near-infrared spectroscopy, recording the spectrum with terahertz spectroscopy, recording the spectrum with microwave spectroscopy, recording direct optical emission of the plurality of molecular species, recording optical absorption of the plurality of molecular species, recording induced fluorescence of the plurality of molecular species, recording Raman scattering of the plurality of molecular species, recording luminescence of the plurality of molecular species, recording phosphorescence of the plurality of molecular species, recording photoacoustics of the plurality of molecular species, and recording photoionization of the plurality of molecular species.

In some embodiments, the method further includes (c) quantifying the abundance of isotopes of an element in the sample. In some embodiments, the method further includes performing operations (a), (b), and (c) on an additional region of the sample. In some embodiments, operation (c) includes generating a simulated spectrum for each of the plurality of molecular species with a mathematical model, performing a numerical fitting of the simulated spectrum of each of the plurality of molecular species to the recorded spectrum, and determining the abundance of the isotopes of the element in the sample from the result of the numerical fitting.

In some embodiments, a specific period of time between operations (a) and (b) increases the intensity of the spectrum generated by the plurality of molecular species in the plasma and decreases the intensity of atomic emission and ionic emission. In some embodiments, the specific period of time depends on a wavelength of the laser energy, a pulse duration of the laser energy, a power of the laser energy, a spot size of the laser energy, and a fluence of the laser energy.

In some embodiments, operations (a) and (b) are performed in ambient air under ambient pressure. In some embodiments, operations (a) and (b) are performed in a chamber. In some embodiments, operations (a) and (b) are performed in a chamber, the chamber containing a specific gas at a specific pressure.

In some embodiments, the method further includes prior to operation (b), exciting the plasma with an additional energy source. In some embodiments, the additional energy source is selected from the group consisting of a microwave field, a radio frequency field, and additional laser energy.

Another innovative aspect of the subject matter described in this disclosure can be implemented a method including (a) applying laser energy to a sample in a first chamber with a laser to generate a first plasma that reacts to form species, (b) transferring the species from the first chamber to a second chamber, (c) imparting energy to the species in the second chamber to form a second plasma, and (d) recording a spectrum generated by a plurality of molecular species in the second plasma in the second chamber with a device.

In some embodiments, the method further includes exciting the second plasma with an additional energy source in the second chamber. In some embodiments, the method further includes exciting the first plasma with an additional energy source in the first chamber.

Another innovative aspect of the subject matter described in this disclosure can be implemented an apparatus including a sample holder configured to hold a sample, a laser, an emission collection system, and a spectrometer coupled to a detector. The apparatus also includes a system controller configured to execute instructions so that the apparatus will perform a method including applying laser energy to a region of a sample with the laser to generate a plasma and recording a spectrum generated by a plurality of molecular species in the plasma using the emission collection system and the spectrometer coupled to the detector.

Benefits of the laser ablation isotope detection technology disclosed herein include rapid, direct chemical (e.g., elemental, molecular, and isotopic) characterization of solid samples without chemical dissolution procedures. A goal is to provide a new technology for isotopic analysis with the potential for laboratory and/or stand-off capability and one that does not require (i) sample preparation or (ii) a non-ambient environment (e.g., vacuum, reduced pressure, inert gas (e.g., N₂, He)) for the sample. Areas where this technology can be applicable include WMD proliferation detection, signatures, nuclear explosion monitoring, general forensics, and others. These analyses may aid in the investigation of proliferation and terrorism activities. Additional applications may be in the climate change, carbon sequestration, medical, and nuclear energy fields, and other fields based on light element and heavy element isotope measurements.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a schematic diagram of an apparatus.

FIG. 2 shows an example of a spectrum showing boron isotope splitting at the appropriate wavelength.

FIG. 3 shows an example of a schematic diagram of an apparatus.

FIG. 4 shows an example of a flow diagram for performing Laser Ablation Molecular Isotopic Spectrometry (LAMIS).

FIG. 5 shows an example of a flow diagram for quantifying the abundance of isotopes in a sample.

FIG. 6 shows an example of a schematic diagram of an apparatus.

FIG. 7 shows an example of a flow diagram for performing LAMIS.

FIG. 8 shows an example of a schematic diagram of an apparatus.

FIG. 9 shows an example of a flow diagram for performing LAMIS.

FIG. 10-19 show examples of plots of data collected with or associated with the embodiments disclosed herein.

### DETAILED DESCRIPTION

### Introduction

More recently, laser induced breakdown spectroscopy (LIBS) has been used for isotopic analysis'¹⁵⁻²². The majority of this work has focused on the analysis of atomic species. In general, to detect emission line of isotopes, the width of spectral line has to be very narrow. Line widths for atomic and ionic emission are narrower in vacuum than at ambient pressure. The uranium II line at 424.437 nm has a U-238/235 isotope shift of 0.025 nm. For Pu I emission line at 594.522 nm, the Pu-239/240 isotope shift is 0.0125 nm. The width of an emission line in a LIBS plasma is the function of temperature and number density of electron. For example, the Si 288 nm line's width will be about 1 cm⁻¹ when electron number density is 10¹⁷ cm⁻³. For a LIBS plasma at ambient pressure, the electron number density is above this range. This is why most of the LIBS isotope detection described in the literature was performed in reduced pressure environments. Reduced pressure was necessary to achieve narrow spectral line width due to both Doppler and Stark broadening; broadening precludes the ability for isotope detection as the two isotope line merge spectrally. The benefits of LIBS are lost in this case, as a vacuum pressure vessel is required and the technology is not field portable. At lower pressures, the laser induced plasma expands much faster, so the electron number density also rapidly decreases. Recent reports of LIBS at atmospheric pressure showing broadened atomic and ionic spectra that are not spectrally resolved, limiting the accuracy of isotopic abundance ratio measurements.

For molecules, the isotopic shift can be much larger¹⁹⁻²⁷. In the laser induced plasma, the sample element atom may react with an oxygen atom in the air and form an oxide species. Previously, several studies have been conducted using LIBS and analyzing molecular emission^{19,27}. These studies, however, were carried out at reduced pressure and, therefore, are more difficult in practice.

Previous similar arts using laser based techniques are limited to reduced pressures and, therefore, require a vacuum system or a sample chamber. Further, in previous similar arts, atomic spectroscopy has been used for isotopic analysis. There are some advantages to using atomic spectroscopy, however, its major drawback is the small isotopic spectral shift for most atoms which is less than 0.25 cm⁻¹. By contrast, isotopic shift for molecules can be orders of magnitude more.

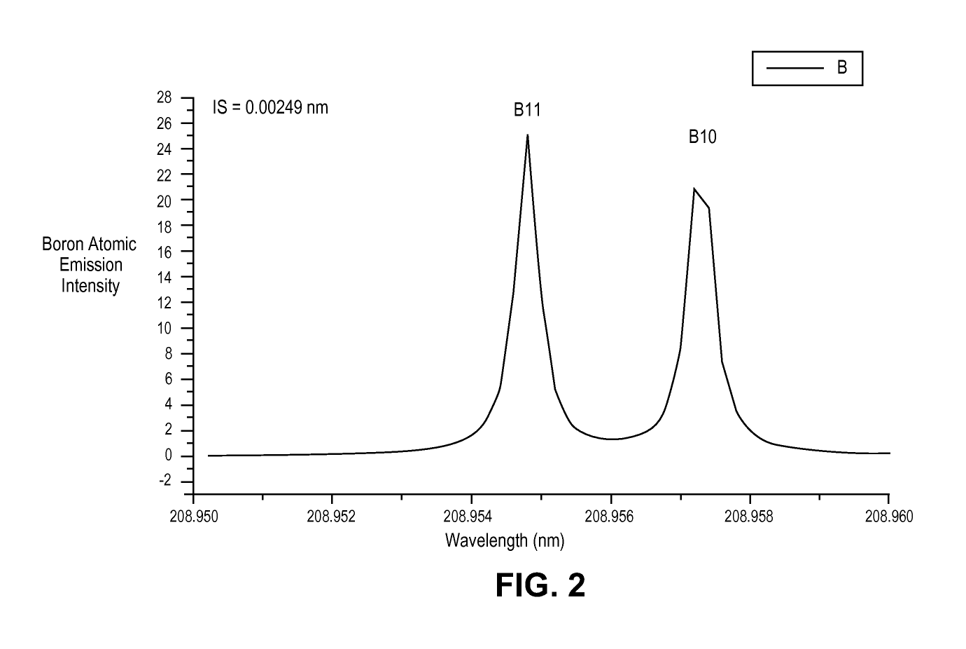

For example, the isotopic shift of atomic boron (B) at 208.889 nm is 0.0025 nm, as shown in FIG. 2. The isotopic shift of atomic boron (B) is almost 3 orders of magnitude less than of molecular boron (e.g., BO). Further details regarding LIBS methods and LIBS systems may be found in U.S. Pat. No. 8,199,321, which is herein incorporated by reference.

Embodiments disclosed herein provide a method of performing isotopic analysis of a sample. Such a method of performing isotopic analysis of a sample may be referred to as Laser Ablation Molecular Isotopic Spectrometry (LAMIS) in the scientific literature. Embodiments disclosed herein provide techniques for isotopic analysis that: (i) may be carried out under atmospheric conditions in the ambient environment (e.g., ambient air); (ii) can be applied to wide range of sample types (i.e., any kind of sample); (iii) may have a high throughput (i.e., rapid analysis of many samples with a high speed of analysis); (iv) may have good discrimination; (v) may have good sensitivity (e.g., down to ppm levels or less); (vi) may require minimal sample preparation or no sample preparation; (vii) may have stand-off capability; and (viii) can be used with a numerical (e.g., Partial Least Squares (PLS), multivariate) algorithm for analysis of data.

In some embodiments, the sample may be in a solid phase or a liquid phase (i.e., the sample may be condensed matter). In some embodiments, the sample may be in a gas phase. In some embodiments, the sample may be an aerosol; an aerosol is a suspension of fine solid particles or liquid droplets in a gas.

### Apparatus and Methods

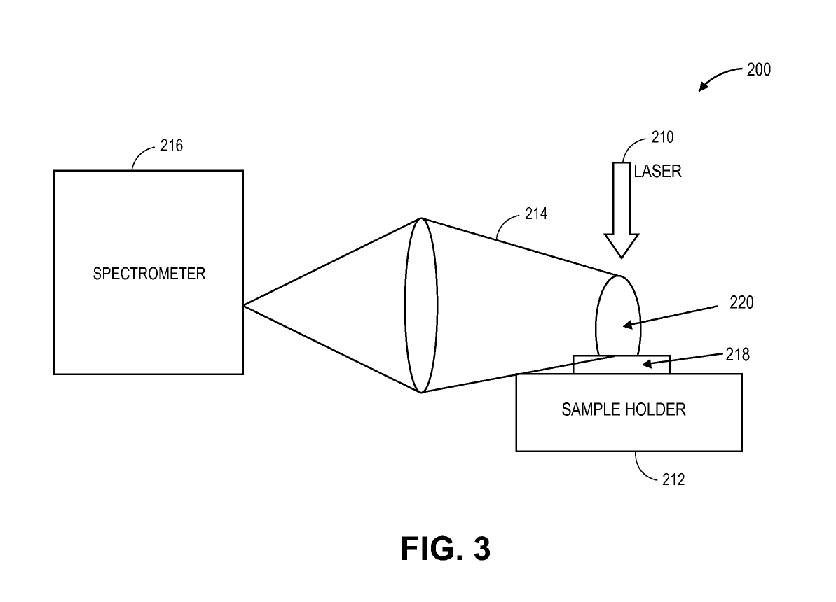

Referring to FIG. 3, in some embodiments an apparatus 200 includes a laser 210, a sample holder 212, an emission collection system 214, and a spectrometer 216. The sample holder 212 is configured to hold a sample 218. The laser 210 is configured to apply laser energy to the sample 218 and generate a plasma 220. The emission collection system 214 is configured to collect optical or electromagnetic emissions from the plasma 220 that may then be input to the spectrometer 216.

In some embodiments, the spectrometer 216 may be operable to detect electromagnetic radiation of a wavelength of about 200 nanometers (nm) to 900 nm. For example, the spectrometer 216 may be operable to detect intensity and wavelength values of the electromagnetic radiation. In some embodiments, the emission collection system 214 may include collection optics configured to receive light from the plasma 220 and a fiber optic cable operable to transmit the light from the collection optics to the spectrometer 216. In some embodiments, a detector that is included as part of the spectrometer may include an intensified charge coupled device (ICCD), a charge-coupled device (CCD), or a photomultiplier tube (PMT).

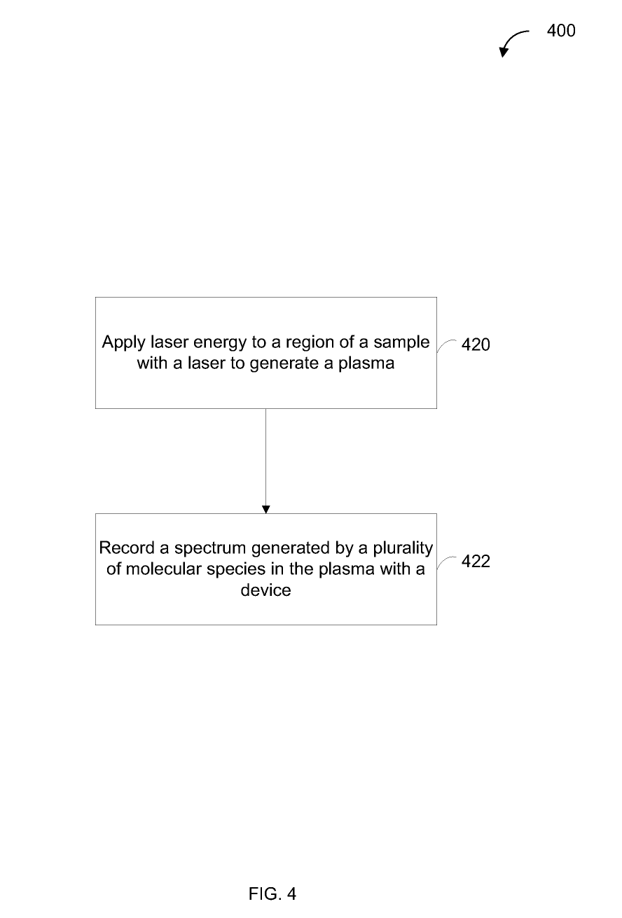

Referring to FIG. 4, in some embodiments a method 400 may be performed with the apparatus 200. Starting with operation 420 of the method 400, laser energy is applied to a region of a sample with a laser to generate a plasma. In some embodiments, the sample may be in a solid phase, a liquid phase, or a gas phase. In some embodiments, the sample may be an aerosol. In operation 422, a spectrum generated by a plurality of molecular species in the plasma is recorded with a spectrometer or other device. For example, with the apparatus 200 shown in FIG. 3, the ablation laser 210 may be used to generate a plasma from the sample, and the emission collection system 214 and the spectrometer 216 may be used to record the spectrum generated by the plurality of molecular species. The spectrometer 216 may detect electromagnetic information (e.g., light) generated by the plasma.

In some embodiments, the laser energy may be applied to the region of the sample in a pulse of laser energy. Any laser wavelength, laser energy, and laser pulse width may be used in operation 420, as long as a plasma is generated. In some embodiments, the laser wavelength may be about 1064 nanometers (nm), the laser energy may be about 50 millijoules (mJ) to 100 mJ, and the laser pulse width may be about 4 nanoseconds (ns). For example, a neodymium doped yttrium aluminum garnet (Nd:YAG) laser may be used to generate energy in the near infrared region of the electromagnetic spectrum with a wavelength of 1064 nm. With a pulse duration of about 4 ns, a laser beam with a power density of greater than one GW/cm² at the laser beam focal point can be formed. In some embodiments, the pulse duration can be decreased to femtoseconds. In some embodiments, the laser beam can be focused to a spot size of about 10 micrometers to 500 micrometers, or about 150 micrometers to 200 micrometers.

In some embodiments, operation 420 may include ablating the sample with the applied laser energy. Such a process may be referred to as laser ablation or ablation.

In some embodiments, operation 420 may include vaporizing the sample with the applied laser energy. In some embodiments, operation 420 may include desorbing the sample with the applied laser energy. In some embodiments, when operation 420 includes vaporizing the sample or desorbing the sample with the applied laser energy, a plasma may not be formed with the applied laser energy. In these embodiments, the method 400 may further include imparting additional energy to the vaporized or desorbed sample to form a plasma including the plurality of molecular species.

In some embodiments, additional energy may be imparted to the plasma. The additional energy may cause molecular species in the plasma to produce additional optical or electromagnetic emissions that can be detected with the spectrometer. In some embodiments, such additional energy may be imparted to the plasma by preforming operation 420 in a microwave field or a radio frequency (RF) field. In some embodiments, such additional energy may be imparted to the plasma with an additional pulse of laser energy. For example, in some embodiments, operation 420 may include applying a first pulse of laser energy at a first angle with respect to the sample, and then applying a second pulse of laser energy at a second angle with respect to the first angle. In some embodiments, the second angle may be about 0 degrees to 90 degrees with respect to the first angle.

The plasma may include ionic, atomic, and molecular species. In some embodiments, the plasma, immediately after application of the laser energy in operation 420, may include a molecular species or a plurality of molecular species. In some embodiments, species atomized from the sample may react with each other to form a molecular species or a plurality of molecular species. The molecular species may include diatoms (e.g., Na_{z}, C₂) or excimers (e.g., He₂, Xe₂, and XeCl), for example.

In some embodiments, the plasma may be allowed to react with species in the surrounding environment to form a molecular species. For example, operation 420 may be performed in ambient air under ambient pressure. Species in the plasma may react with oxygen or nitrogen, for example, in the air to form oxide molecular species or nitride molecular species, respectively. Whether the as-formed plasma includes molecular species depends in-part on the laser wavelength, the laser pulse duration, the laser power, the laser spot size, and the laser fluence. When the plasma is allowed to react with species in the surrounding environment to form a molecular species, the time needed for such a reaction or reactions also depends in-part on the laser wavelength, the laser pulse duration, the laser power, the laser spot size, the laser fluence, the sample, and the molecular species.

The recording of a spectra generated by molecular species (i.e., molecular emission) versus recording a spectra generated by atomic species (i.e., atomic emission) is one difference between the embodiments disclosed herein (e.g., LAMIS) and the laser induced breakdown spectroscopy (LIBS) technique. Generally, in LIBS a spectrum is recorded after laser energy is imparted to a sample (e.g., a short delay of about 1 microsecond or less) to reduce or minimize spectral line broadening and the background. The delay time depends in part on the laser energy and the sample.

In some embodiments, a period of time between operations 420 and 422 is set or specified to increase or maximize the intensity of molecular emission and to decrease or minimize atomic emission and ionic emission (i.e., emission from atoms and atomic ions). Again, this period of time depends in part on the laser wavelength, the laser pulse duration, the laser power, the laser spot size, the laser fluence, the sample, and the molecular species.

As noted above, in operation 422, optical or other electromagnetic emission generated by the plasma may be recorded by a spectrometer or other device. In some embodiments, operation 422 includes recording the spectrum with visible spectroscopy, recording the spectrum with ultraviolet spectroscopy, recording the spectrum with infrared spectroscopy, or recording the spectrum with near-infrared spectroscopy. In some embodiments, operation 422 includes recording direct optical emission of the plurality of molecular species, recording optical absorption of the plurality of molecular species, recording induced fluorescence of the plurality of molecular species, recording Raman scattering of the plurality of molecular species, recording luminescence of the plurality of molecular species, recording phosphorescence of the plurality of molecular species, recording photoacoustics of the plurality of molecular species, or recording photoionization of the plurality of molecular species.

In some embodiments, the method 400 may be performed more than once or a plurality of times on the same region of the sample. The recorded spectrum for each repetition of the method 400 may then be averaged. For example, in some embodiments, the method 400 may be repeated two times or three times on a region of a sample. Performing the method 400 on the same region of the sample multiple times and averaging the results may yield a spectrum with less noise and less experimental error.

In some embodiments, the method 400 shown in FIG. 4 may further include quantifying the abundance of isotopes of an element in the sample. As known by one of ordinary skill in the art, isotopes of an element all have the same number of protons. Isotopes, however, differ from each other by having different numbers of neutrons. Different elements have different numbers of isotopes; some elements have one isotope, but most elements have more than one isotope.

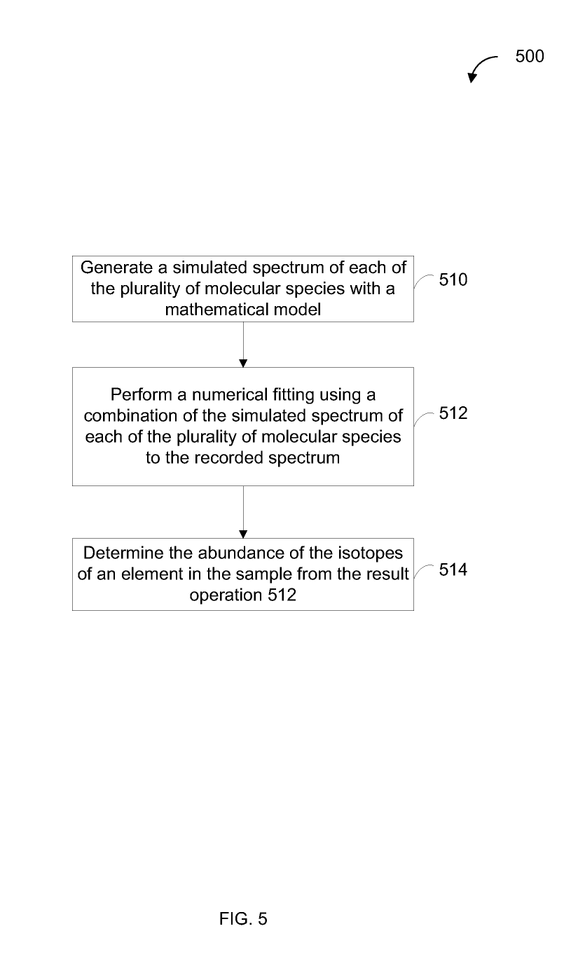

Referring to FIG. 5, a method 500 of quantifying the abundance of isotopes in the sample starts with operation 510. In operation 510, a simulated spectrum of each of the plurality of molecular species in the plasma is generated with a mathematical model. In operation 512, a numerical (e.g., least squares) fitting of the simulated spectrum of each of the plurality of molecular species to the recorded spectrum is performed. In operation 514, the abundance of the isotopes of an element in the sample from the result of operation 512 is determined.

For example, in a sample having two isotopes of an element, the recorded spectrum may be fit with the simulated spectrum of each isotope of the element by varying the fraction of each isotope when performing a least squares fitting. That is, each simulated spectrum is multiplied by a percentage (with the percentages adding up to 100%) and the resulting simulated spectra are summed; the percentages are varied to best match the sum of the simulated spectra to the measured spectrum. The percentage assigned to each simulated spectra is the percentage of each isotope of the element in the sample. Experimental results of such a procedure, including a mathematical model which may be used to simulate the spectra of the molecular species, are described below in EXAMPLE 1.

In some embodiments, operation 510 includes simulating the spectrum of each of the molecular species for direct optical emission, simulating the spectrum of each of the molecular species for optical absorption, simulating the spectrum of each of the molecular species for induced fluorescence, simulating the spectrum of each of the molecular species for Raman scattering, simulating the spectrum of each of the molecular species for luminescence, simulating the spectrum of each of the molecular species for phosphorescence, simulating the spectrum of each of the molecular species for photoacoustics, or simulating the spectrum of each of the molecular species for photoionization.

In some embodiments, instead of simulating the spectrum of each of the plurality of molecular species in operation 510, spectra from samples with a known abundance of isotopes may be recorded. For example, samples with a known abundance of isotopes may be obtained from an agency such as the National Institute of Standards and Technology (NIST). These recorded spectra, instead of simulated spectra, may be used in the numerical fitting procedure of operation 512.

In some embodiments, both simulated spectra and recorded spectra are used to calibrate a system. In some embodiments, a multivariate calibration may be performed. In some embodiments, a multivariate calibration may include recording spectra from a plurality of samples, each of the samples having a known but different abundance of isotopes. These recorded spectra may be used to determine isotope ratios in a sample having an unknown abundance of isotopes.

For example, a partial least squares (PLS) linear regression routine may be used to match a spectrum of an unknown sample to one of the reference spectra. The PLS routine may be applied to obtain a multivariate calibration that takes into all intensities at most or every pixel within the wavelength range of interest. This multivariate calibration is different from the traditional univariate calibration, which is usually built using only one pre-selected spectral line (or other single spectral feature) at a specific wavelength. In some embodiments, the multivariate approach is more accurate, robust, and reliable in comparison to univariate calibration. Further, multivariate calibration can be performed correctly even when spectra are only partially resolved; this aspect is particularly important for molecular spectra.

In some embodiments, the method 400 shown in FIG. 4 and the method 500 shown in FIG. 5 may be performed on a different region of the sample. By doing this, variations in the abundance of an isotope or isotopes in different regions of the sample may be determined.

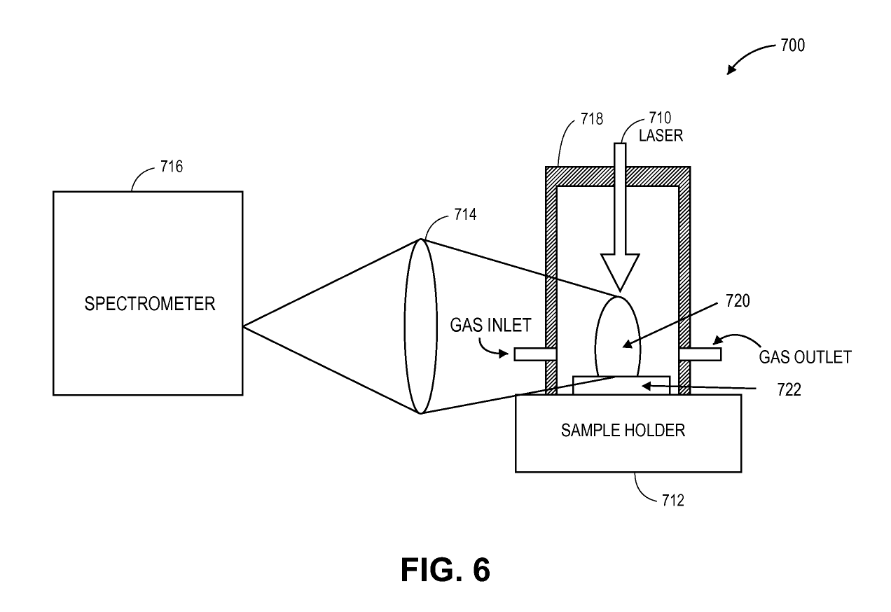

Referring to FIG. 6, in some embodiments an apparatus 700 includes a laser 710, a sample holder 712, an emission collection system 714, a spectrometer 716, and a chamber 718. The sample holder 712 is configured to hold a sample 722. The laser 710 is configured to apply laser energy to the sample 722 and generate a plasma 720. The emission collection system 714 is configured to collect optical or electromagnetic emissions from the plasma 720 that may then be input to the spectrometer 716.

The chamber 718 may contain a specific gas or gasses at a specific pressure or pressures. The gas or gasses may be specified, depending on the sample being analyzed, such that desired molecular species may be formed that aid in quantifying the abundance of isotopes in the sample. For example, a gas may be selected such that the spectra formed by two molecules, each including a different isotope of an element, in the sample have an isotopic spectral shift that is able to be resolved by the spectrometer being used. Further, the sample inside the chamber may be held at a specific temperature. When a sample is held at one temperature versus a different temperature, different molecular species may be formed in the plasma. Using such an apparatus 700, some control over molecular species formed when the plasma reacts with the environment may be achieved; i.e., by controlling the plasma properties, the formation of specific molecules can be controlled.

In some embodiments, to control the gas or gasses with which the plasma may react, the chamber 718 may not be used. Instead, in some embodiments, tubes or other devices may be used to deliver a gas to the region where the plasma is to be formed.

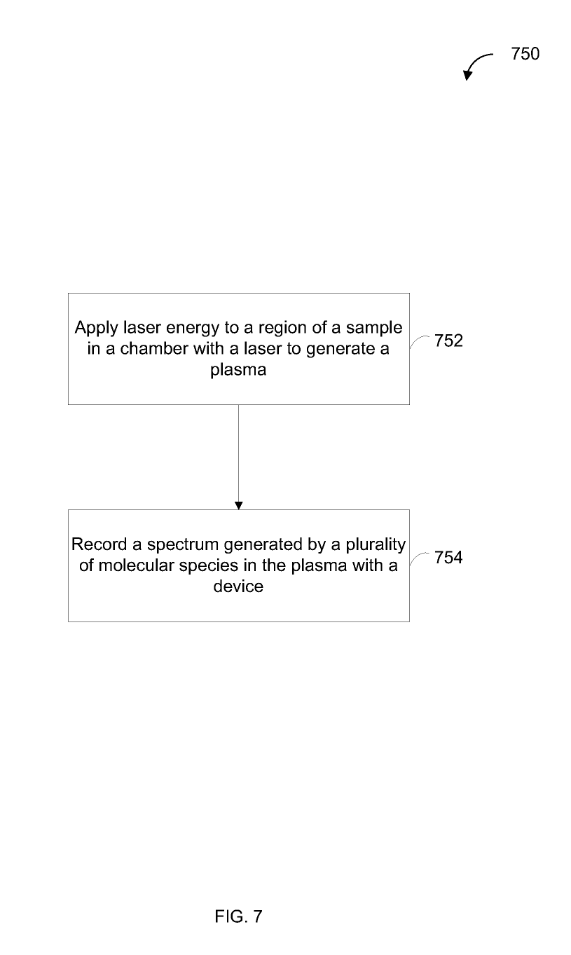

Referring to FIG. 7, in some embodiments a method 750 may be similar to the method 400 shown in FIG. 4. Starting with operation 752 of the method 750, laser energy is applied to a region of a sample with a laser to generate a plasma. The plasma generated in operation 752 may be generated in the chamber 718 of the apparatus 700. The chamber 718 may contain a specific gas or gasses at a specific pressure or pressures. In operation 754, a spectrum generated by a plurality of molecular species in the plasma is recorded with a spectrometer or other device.

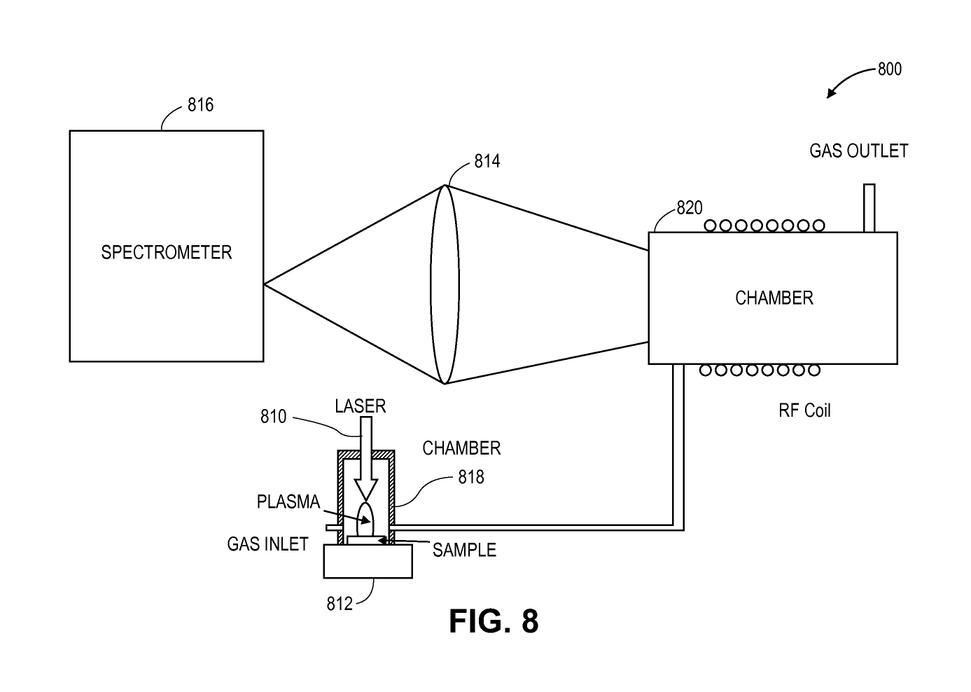

Referring to FIG. 8, in some embodiments an apparatus 800 includes a laser 810, a sample holder 812, an emission collection system 814, a spectrometer 816, a first chamber 818, and a second chamber 820.

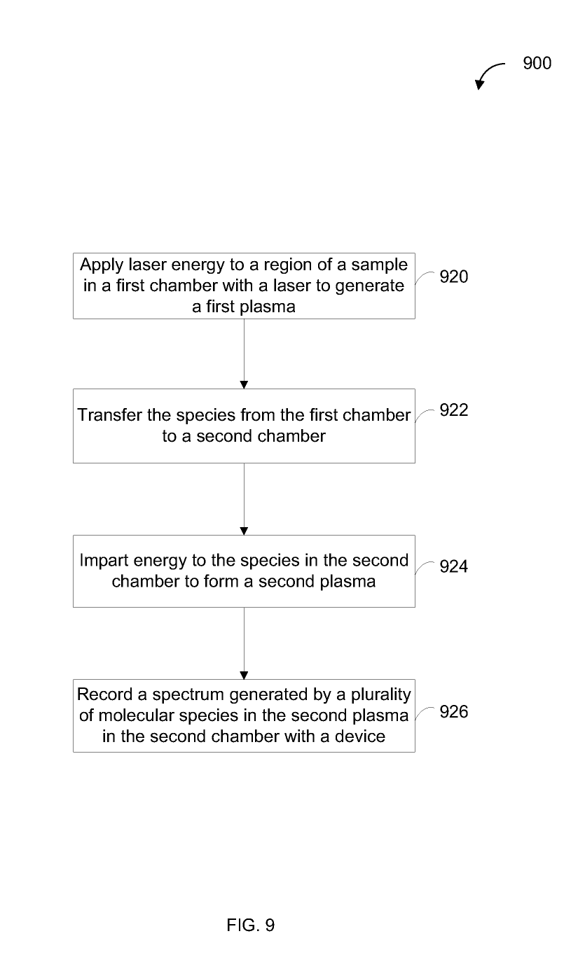

Referring to FIG. 9, in some embodiments a method 900 may be similar to the method 400 shown in FIG. 4. Starting with operation 920 of the method 900, laser energy is applied to a region of a sample in a first chamber with a laser to generate a first plasma. For example, the plasma generated in operation 920 may be generated in the first chamber 818 of the apparatus 800 shown in FIG. 8. The first chamber 818 may contain a specific gas or gasses at a specific pressure or pressures. The plasma may react with the specific gas or gasses to form a species.

In operation 922, the species may be transferred from the first chamber to a second chamber. For example, the species may be transferred from the first chamber 818 to the second chamber 820 of the apparatus 800 shown in FIG. 8. In operation 924, energy is imparted to the species in the second chamber to form a second plasma. In operation 926, a spectrum generated by a plurality of molecular species in the second plasma is recorded with a spectrometer or other device.

The apparatus 800 may allow for more control of the second plasma in the second chamber 820. For example, a second plasma in the second chamber may be more stable (e.g., it may last for a longer time period). Further, a second plasma in the second chamber may be under conditions that are more favorable to form a desired molecular species.

In some embodiments, additional energy may be imparted to the plasma in the first chamber. In some embodiments, additional energy may be imparted to the plasma in the second chamber. As noted above with respect to FIG. 4, the additional energy may cause molecular species in the plasma to produce additional optical or other electromagnetic emissions that can be detected with the spectrometer. In some embodiments, such additional energy may be imparted to the plasma with a microwave field, a RF field, or an additional pulse of laser energy.

In some embodiments, the methods 400 (described with respect to FIG. 4), 750 (described with respect to FIG. 7), and 900 (described with respect to FIG. 9) may all be followed by the method 500 (described with respect to FIG. 5) to quantify the abundance of isotopes of an element in a sample. Further, in some embodiments, the details described with respect to the method 400 may be applicable to the methods 750 and 900.

Another aspect of the embodiments disclosed herein is an apparatus with a system controller configured to accomplish the methods described herein. For example, a suitable apparatus includes hardware for accomplishing the process operations and a system controller having instructions for controlling process operations in accordance with the disclosed embodiments. Hardware for accomplishing the process operations may include an energy source (e.g., a laser), a sample holder, an emission collection system, and a spectrometer coupled to a detector. The system controller will typically include one or more memory devices and one or more processors configured to execute the instructions so that the apparatus will perform a method in accordance with the disclosed embodiments. Machine-readable media containing instructions for controlling process operations in accordance with the disclosed embodiments may be coupled to the system controller.

The embodiments disclosed herein are described below in greater detail by way of specific examples. The following examples are offered for illustrative purposes, and are intended not to limit the invention in any manner. Further details regarding the embodiments described above and the examples set forth below may be found in the following publications, all of which are herein incorporated by reference:
R. E. Russo, A. A. Bol'shakov, X. Mao, C. P. McKay, D. L. Perry, O. Sorkhabi, Laser Ablation Molecular Isotopic Spectrometry, Spectrochimica Acta Part B, 66, 99-104 (2011);
Xianglei Mao, Alexander A. Bol'shakov, Dale L. Perry, Osman Sorkhabi, Richard E. Russo, Laser Ablation Molecular Isotopic Spectrometry: Parameter influence on boron isotope measurements, Spectrochimica Acta Part B, 66, 604-609 (2011); and
Xianglei Mao, Alexander A. Bol'shakov, Inhee Choi, Christopher P. McKay, Dale L. Perry, Osman Sorkhabi, Richard E. Russo, Laser Ablation Molecular Isotopic Spectrometry: Strontium and its isotopes, Spectrochimica Acta Part B, 66, 767-775 (2011).

### Example 1

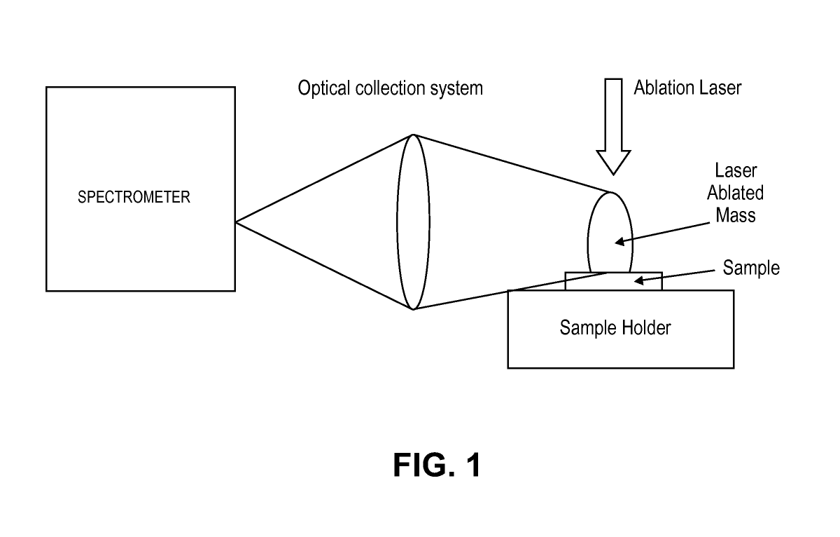

The equipment used to perform some embodiments described herein is that of a laser induced breakdown spectroscopy (LIBS) setup as shown FIG. 1. A laser beam is focused onto a sample to ablate a small amount of the sample. The ablation process generates a plasma which contains ionic, atomic, and molecular species. Optical emission from the plasma contains a unique spectral ‘fingerprint’ for the sample that was ablated.

It has been demonstrated that by analyzing optical molecular emission from the plasma, signal could be discriminated from different isotopes that were present in the sample. The laser wavelength in this example/experiment was 1064 nm, the laser energy was 100 mJ, and laser pulse width was 4 ns. However, any laser wavelength, energy, and pulse width could be used as long as it generates a plasma. In this experiment, an Intensified Charge Coupled Device system (ICCD) was coupled to the spectrometer for the detection of plasma optical emission.

Molecular electronic transition wavelength depends on the difference of two electronic states and can be calculated, for example, using the following formula:

v=T″−T″=(Tₑ′−Tₑ″)+(G′−G″)+(F′−F″) (1)

where the single primed letters refer to the upper state and double primed letters refer to the lower state. Tₑ is electronic energy, G is the vibrational energy, and F is the rotational energy. G is a function of the vibrational quantum number v and F is a function of the rotational number J:

$$G = {ω}_{e} ( v + \frac{1}{2} ) - {ω}_{e} {{x}_{e} ( v + \frac{1}{2} )}^{2} + {ω}_{e} {{y}_{e} ( v + \frac{1}{2} )}^{3} + … \\ F = {B}_{v} J ( J + 1 ) - {D}_{v} {{J}^{2} ( J + 1 )}^{2} + … \qquad ( 2 )$$

For different molecular isotopes, the vibrational and rotational energies are a function of

$$ρ = \sqrt{\frac{μ}{{μ}^{i}}}$$

where μ is the reduced mass of molecule and i denotes the isotope:

wₑⁱ=ρwₑwₑⁱxₑⁱ=ρ²wₑxₑBᵥⁱ=ρ²Bᵥ (3)

Equations 1-3 can be used to calculate spectral shifts—also known as isotopic shift—for differential molecular isotopes.

For isotope detection, the isotopic shift (IS) of vibrational band head or the rotational line positions can be used. For vibrational band head difference, IS is given by:

$$Δ v = ( 1 - ρ ) [ {ω}_{e}^{′} ( {v}^{′} + \frac{1}{2} ) - {ω}_{e}^{″} ( {v}^{″} + \frac{1}{2} ) ] - ( 1 - {ρ}^{2} ) [ {ω}_{e}^{′} {{x}_{e}^{′} ( {v}^{′} + \frac{1}{2} )}^{2} - {ω}_{e}^{″} {{x}_{e}^{″} ( {v}^{″} + \frac{1}{2} )}^{2} ] \qquad ( 4 )$$

According to Eq. 4, IS is large if the difference between quantum number v is also large. When choosing vibrational band head for isotopic detection, the largest differential of v number with a reasonable emission intensity should be used.

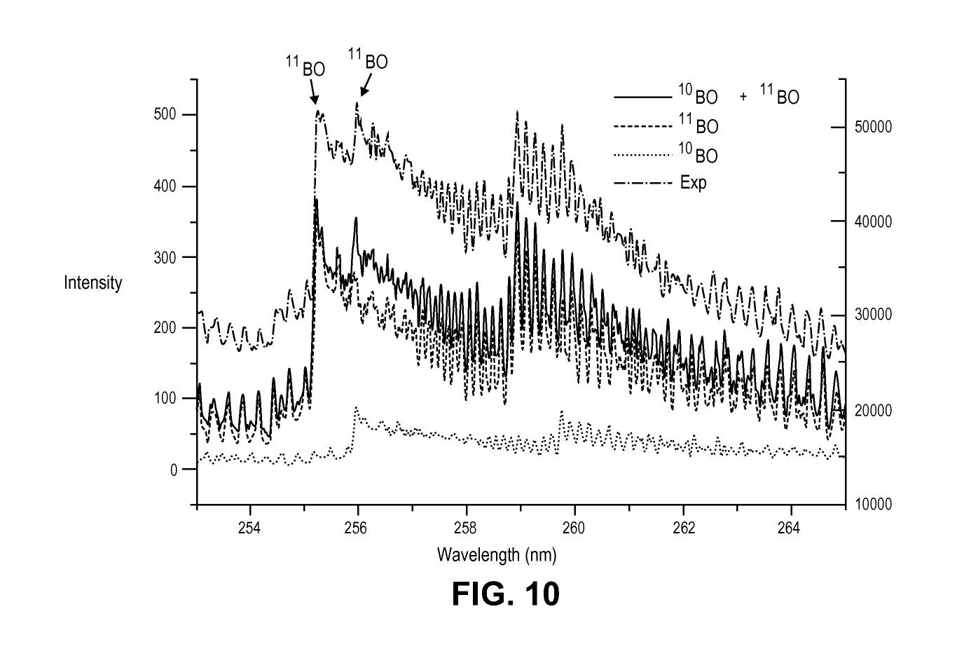

FIG. 10 shows the vibrational band head positions for ¹⁰BO and ¹¹BO and demonstrates the large molecular isotopic shift. The dashed/dotted line plot is the experimental data. The dashed and dotted plots are the calculated emission spectra (e.g., using equations (1)-(3)) for ¹¹BO and ¹⁰BO, respectively. The solid line plot is the combination of ¹¹BO and ¹⁰BO calculated emission spectra. The emission spectra in FIG. 10 represents transitions of the B²Σ⁺ (v=0)→X ²Σ⁺ (v=2) electronic system of boron monoxide corresponding to transitions from v′=0 of the upper electronic state, B ²Σ⁺, to v″=2 of the ground electronic state, X ²Σ⁺. Such a transition is referred to as the (0,2) band of the B ²Σ⁺→X ²Σ⁺ system. The isotope shift for this band is 0.73 nm.

Compared to the atomic IS (e.g., see FIG. 1), the molecular IS is greatly enhanced. The IS of B ²Σ⁺-X ²Σ⁺ (0′-3″) is even large (1.14 nm). The emission intensity, however, is weaker. For the B-O B ²Σ⁺-X ²Σ Band, the (0-2) band is the best for boron monoxide isotope detection.

For isotope detection, the rotational structure also can be used. The isotope shift for rotational energy is:

ΔF=(1−ρ²)└Bᵥ_{^{′}}J′(J′+1)−Bᵥ_{^{″}}J″(J″+1)┘ (5)

IS, according to Eq. 5, depends on both vibrational quantum and rotational quantum numbers. From Eq. 5, the isotopic shift from rotation band also increases with J and v. A wide range of rotational structure from 350 nm to 700 nm can be used detect isotopes.

The results presented in FIG. 10 demonstrate the isotopic detection capabilities using molecular emission. Such data can be used to quantify the concentration of isotopes. One way is to fit the calculated emission spectra to the experimental data.

For example, the experimental data presented in FIG. 10 were fitted in order to determine the isotopic concentration. Using a least squares fitting technique, the experimental data was fitted by allowing the isotopic fraction to vary.

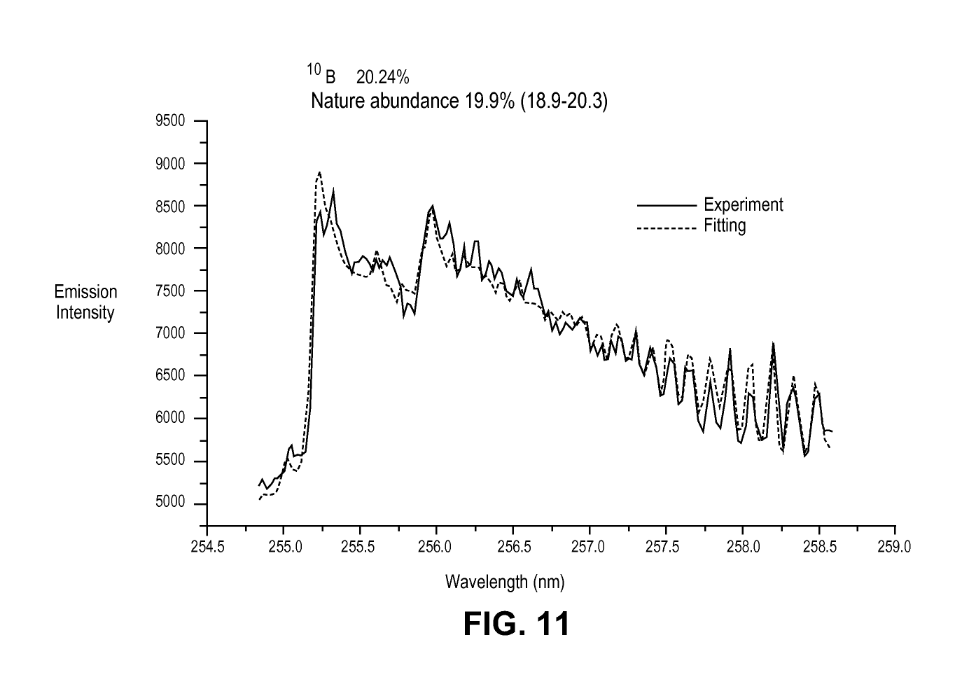

FIG. 11 shows the experimental data (solid) and fitted calculated curve (dashed). The least squares fit resulted in concentration of 20.2% for ¹⁰B. The natural abundance of ¹⁰B is 19.9%, which is very close to the calculated result. These results demonstrate that least squares fitting could provide quantitative isotopic information.

The embodiments disclosed herein were further demonstrated by using emission of diatomic molecules, such as OH, CN, C₂, BO, and SrO. This method can also be applied to other samples.

### Example 2

Samples with known boron isotopic ratio were ablated using a Nd:YAG laser with wavelength 1064 nm, a pulse energy of 50 mJ to 100 mJ, and a pulse duration of 4 ns. The laser beam was focused onto the sample with a quartz lens to a spot diameter of about 100 micrometers (μm). A second lens was used to collect the laser-induced plasma emission onto the entrance of a fiber optic cable coupled to a Czerny-Turner spectrometer with an Intensified Charge-Coupled Device (ICCD). The signal acquisition delay after the laser pulse was varied to demonstrate the relative intensities for atomic, ionic, and molecular emission. The spectra represent accumulation of single or multiple laser pulses; the number of pulses for each measurement is noted in the figure descriptions. Additional measurements were performed at different spectral resolutions by changing the entrance slit width of the spectrometer. The spectral resolution was determined by measuring the full width at half maximum (FWHM) of the Hg line. All measurements were performed in air at atmospheric pressure.

A double-pulse setup of some embodiments consisted of two lasers and a detection system. The wavelength of the ablation laser was 355 nm, and its pulse energy was 8.5 mJ. The second laser's wavelength was 1064 nm with a pulse energy of 75 mJ. The second laser propagated orthogonal to the first ablation laser. The time delay between the two laser pulses was 2.4 microseconds (μs). The second laser pulse was focused inside the first laser induced plasma at a height approximately 1 millimeter (mm) above the sample surface. The ICCD acquired spectra at 8 μs delay after the ablation laser. The gated acquisition time was 30 μs. In some embodiments, the pulse could include laser energy, microwave energy, or a spark.

Boron nitride (BN) pressed-powder disks with natural isotopic abundance were used as samples. These BN disks were commercial sputtering targets designed for film deposition in the electronics and optical industry (obtained from Alfa Aesar (Ward Hill, Mass.), 99.99% purity). Additionally, isotope-enriched samples of ¹⁰B₂O₃ and ¹¹B₂O₃ (99% ¹⁰B and 95% ¹¹B) were used as reference standards. The boron oxide samples were purchased from Cambridge Isotope Laboratories, Inc. (Andover, Mass., USA). To prepare the different isotope ratio boron oxide reference samples, different amounts of isotope-enriched B₂O₃ were mixed and then pressed with a 7 ton pressure for 4 minutes into one-centimeter diameter pellets.

It has been demonstrated that isotopic shifts can be orders of magnitude larger in molecular versus atomic optical emission²⁸. In some embodiments, an ablating laser pulse is impinged on the sample surface that results in explosive vaporization, atomization, and partial ionization of matter from the sample and surrounding air. After the plasma in a plume cools down sufficiently, the molecular radicals form. In particular, the diatomic oxide radicals form when atoms evaporated from the sample react with dissociated atmospheric oxygen. A small deviation in plasmochemistry of different isotopes of the same element may occur, but in general all isotopes undergo very similar reactions. Quantitative calibration then relates the measured spectra of radicals in an ablation plume to the original abundances of isotopes in the sample.

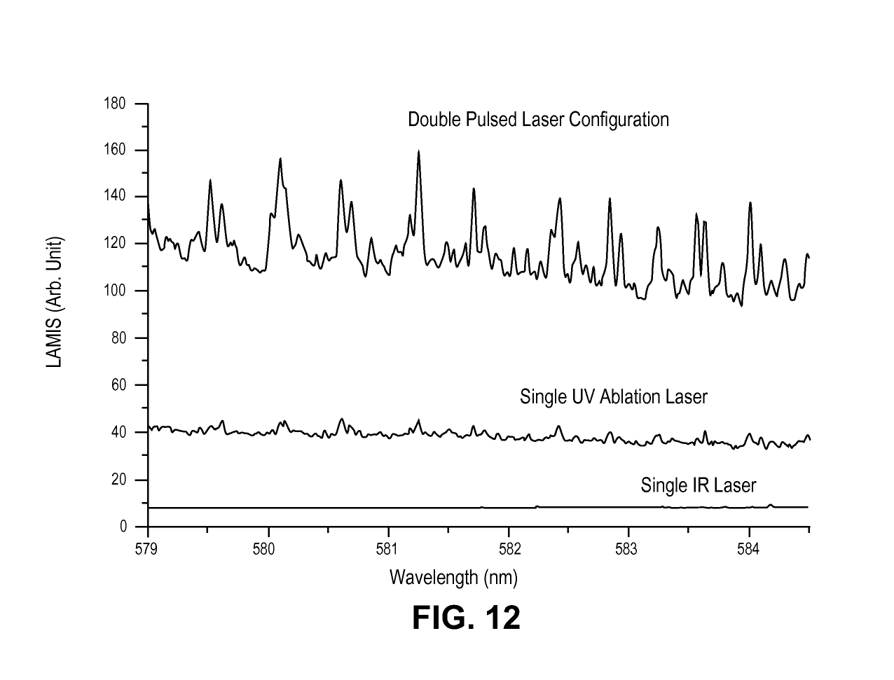

The double-pulse approach, according to some embodiments, in which a second laser pulse is coupled into a laser plasma with a short delay after the first pulse, has been shown to increase atomic and ionic emission^{29,30}. Similar enhancements were measured for molecular emission as shown in FIG. 12. The ablated mass in both double-pulse and single-pulse measurements was the same. Therefore, enhancement in intensity of molecular spectra can be attributed to higher electronic and collisional excitation of molecules in the double-pulse approach. However, it is clear from these data that sensitivity could be increased.

FIG. 12 shows BO emission spectra from laser ablation of the BN sample measured in the double-pulse scheme. The bottom trace shows the effect of firing the second laser without the first ablation pulse. The middle spectrum corresponds to single laser pulse ablation. The top spectrum corresponds to application of the two laser pulses separated by ˜1 μs; emission is enhanced by additional heating of laser plasma. All data recorded is from accumulating 100 spectra.

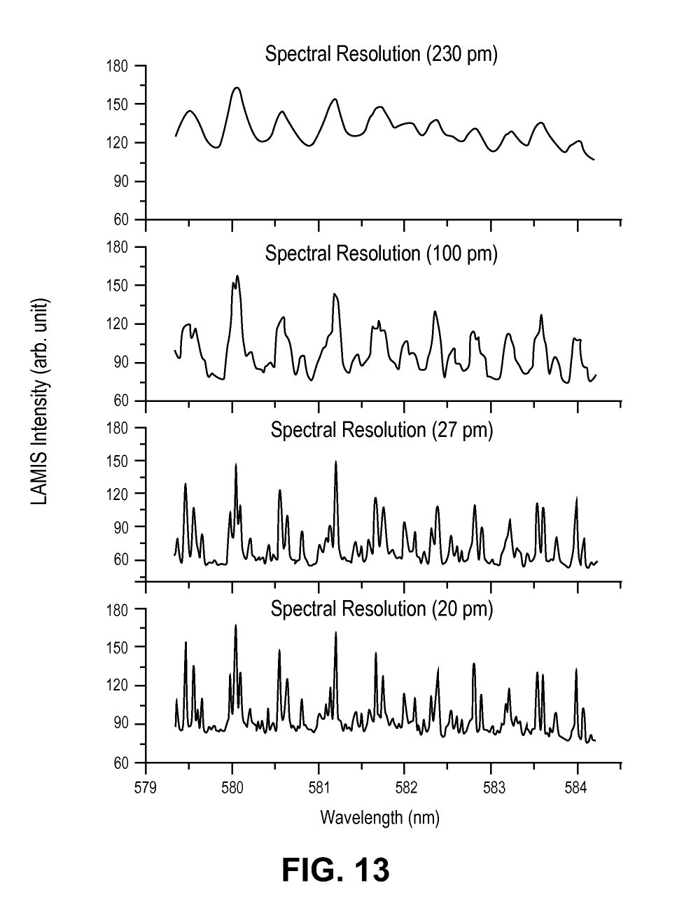

The large isotopic spectral shift in molecular transitions observed in this experiment relaxed requirements on resolution of the spectrometer. In order to investigate the effect of spectral resolution, the resolution of the spectrometer used with was varied from 20 pm to 230 pm, as shown in FIG. 13. FIG. 13 shows BO emission spectra from laser ablation of BN sample measured with different spectral resolution (20 pm, 27 pm, 100 pm, and 230 pm), with delay of 4 μs and gate width of 30 μs.

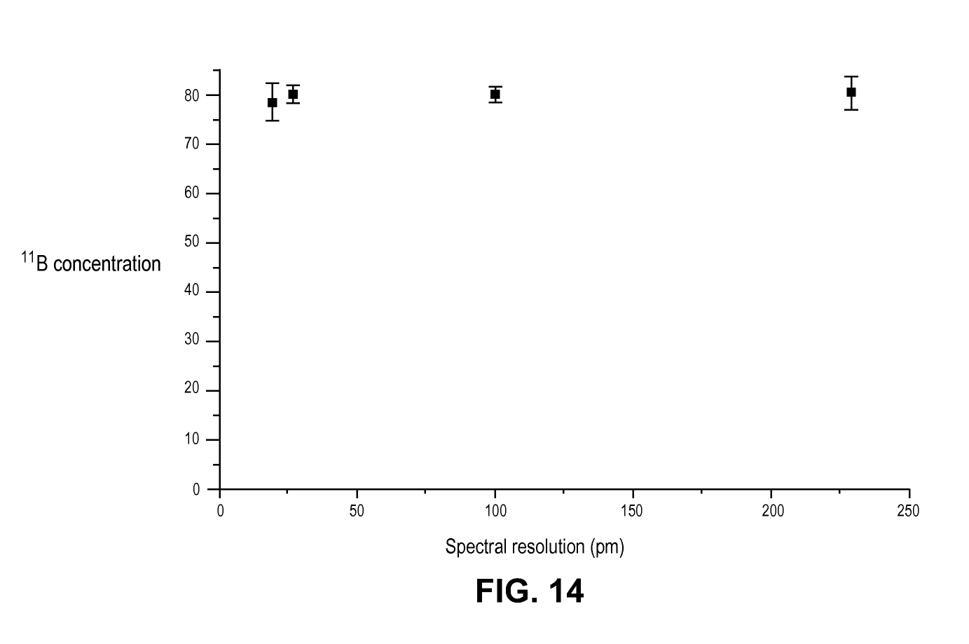

As shown in FIG. 14, calibration in accordance some embodiments (e.g., built using the same PLS routine as described earlier and established from the series of 100 single pulse spectra) did not change within an experimental standard relative deviation of ˜3.5%. All data with varied resolution combined together resulted in a value of (79.6±2.8) % of ¹¹B isotope abundance in the BN sample, which is in agreement with the natural abundance range of 79.8% to 80.7%³¹. Therefore, high-resolution spectrometers may not be necessary for the quantitative measurements. The ability to measure isotope abundance with a low resolution spectrometer is a significant attribute of some embodiments. FIG. 14 shows the concentration of ¹¹B in the BN sample as predicted by PLS calibration versus spectral resolution of the recording spectrometer.

### Example 3

In another experiment, laser energy was applied to vapors of ordinary water (H₂O) and heavy water (D₂O) and the OH and OD molecular emission from the plasma plume was measured. Molecular spectra in a laser-generated plasma became relatively stronger at long delays in the afterglow. The gate width of the ICCD detector was set to 60 μs with the delay of 25 μs, contrary to a usual value of ˜1 μs typically used for atomic detection in LIBS measurements.

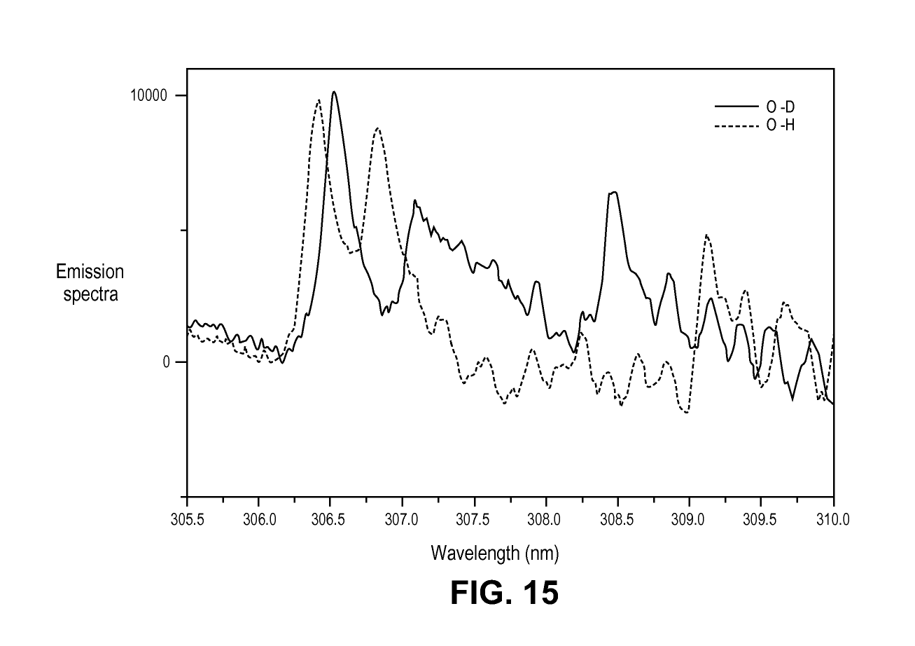

The data shown in FIG. 15 demonstrate the prominent spectral features of OH A ²Σ+-X²Πi (0,0) transition at ˜306 nm (R₁, R₂ branch heads) and ˜309 nm (Q₂ branch head) with partially resolved individual rotational lines. The experimental shift between the Q₂ branch heads of OH and OD was approximately 0.68 nm. This shift was larger than the separation of 0.18 nm between H and D atomic lines at 656.29 nm and 656.11 nm, respectively. However, more important in this case was that the hydroxyl spectra were significantly less prone to Stark broadening than the atomic lines of H and D. Spectral lines of light atoms such as hydrogen and deuterium could be broadened up to ˜1 nm width in laser ablation plasmas. Segregation of H and D has been measured in laser induced and DC arc plasmas^{32,33}. The possibility of segregation could influence these molecular spectral measurements, and needs to be investigated. However, at the long delay time and atmospheric pressure used in this work, multiple collisions between ablated and atmospheric species would likely equilibrate the spatial isotopic distribution. FIG. 15 shows the emission band of OH and OD generated from water and deuterium oxide, respectively, where the dashed curve represents the OH spectrum, while the solid curve represents the OD spectrum, with spectra accumulated from 600 laser pulses.

Simulation of the ¹⁶OH, ¹⁸OH, and ¹⁶OD vibronic spectra demonstrated that sufficient spectral resolution (˜0.03 nm) to selectively detect all these species simultaneously can be attained with modern compact echelle-based spectrometers. In laser ablation, the number density of species vaporized in each laser shot is usually 10¹⁵ cm⁻³ to 10¹⁹ cm⁻³. Most of the molecular species in a plume ejected from ice are expected to be ¹⁶OH. Following the isotopic abundances, a number of ¹⁸OH radicals will be approximately 500 times less. Therefore, the estimated ¹⁸OH number density of at least ˜10¹² cm⁻³ in a laser-vaporized plume from water/ice can be expected. Such quantities of species are readily detectable in emission spectroscopy. The real-time determination of oxygen isotopes from ice may be of significant consequence to studies in paleoclimatology, hydrogeology, and glaciology.

### Example 4

In another experiment, carbon isotopic signatures were measured using diatomic CN and C₂ radicals that are known to form effectively in laser ablation plumes and are among the well-investigated species. The experiments were performed with regular graphite (99% ¹²C) and isotopically enriched urea (99% ¹³C) as the samples. The C₂ from the sample and N₂ from ambient air are the precursors for CN formation in the laser ablation plasma. The CN radicals are generated in comparable abundance to C₂ and both these species are routinely observed in LIBS of carbon-containing samples. At near-threshold ablation of graphite, vapor in the plume is dominated by C₂ and C₃ radicals that are directly ejected as the intact molecules. Evaporation of carbon in the molecular versus atomic form is thermodynamically favored because of relatively high bond energies of C₂ and C₃. With the increasing laser fluence, molecular emission remains roughly constant while atomic carbon emission increases drastically indicating the major fraction of the plume becomes atomized³⁴.

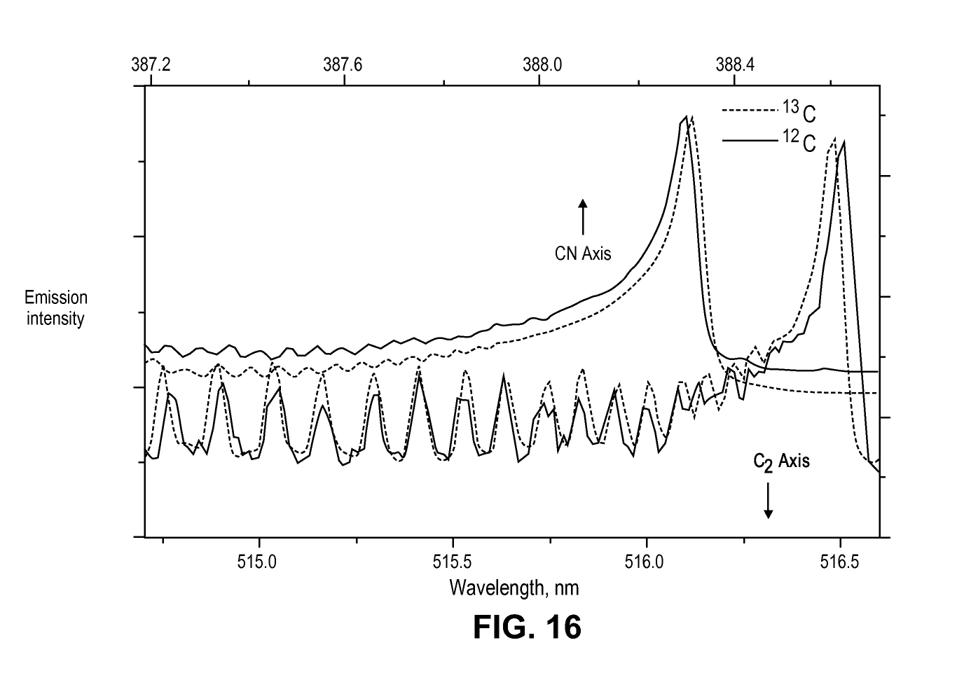

The spectra of C₂ and CN with resolved features attributed to ¹²C and ¹³C isotopes as measured in laser ablation plasma are shown in FIG. 16. The data in FIG. 16 display the (0,0) band head regions of the C₂ d³Π_{g}-a³Πᵤ (Swan system) and CN B²Σ+-X²Σ+ transitions, respectively. The isotopic shifts in the band heads of both radicals were similar and approximately equal to ˜0.03 nm. However, the heavier isotope spectrum in CN was shifted toward the violet, but the counterpart in C₂ was shifted toward the red. Simulation of the C₂ spectrum in the region 875 nm to 890 nm of the Phillips band (2,0) of the electronic system A¹Πᵤ-X¹Σg+ indicated that the isotopic shift between ¹²C and ¹³C can be as large as ˜0.3 nm. A similar conclusion was drawn from the simulation of ¹²C¹⁴N and ¹³C¹⁴N spectra in the region of the A²Πᵢ-X²Σ+ (1,0) transition between 925 nm and 940 nm. In the latter wavelength region, the three isomeric molecules ¹²C¹⁴N, ¹³C¹⁴N, and ¹²C¹⁵N can be individually resolved with a resolution of ˜0.03 nm. FIG. 16 shows the emission spectra of CN and C₂ generated from ¹³C-enriched urea and predominantly ¹²C graphite.

### Example 5

In another experiment, samples with known strontium isotopic content were ablated using a Nd:YAG laser with a wavelength of 1064 nm, a pulse duration of 4 ns, and an adjustable pulse energy within 50 mJ to 100 mJ. The laser beam was focused by a quartz lens on the sample surface to a spot diameter of ˜100 μm. A second lens was used to collect the emission from the laser ablation plasma onto the entrance of a fiber optic cable coupled to one of the two Czerny-Turner spectrographs available for this work. An Acton SpectraPro SP2150 spectrograph with a 150 mm focal length and two exchangeable gratings was used for low resolution measurements. These two gratings (150 gr/mm and 600 gr/mm) provided spectral resolution of 5 nm and 1.3 nm, respectively. High resolution measurements were performed using a Horiba JY 1250M spectrograph with a 1250 mm focal length and a grating of 1200 gr/mm. The spectral resolution was 0.04 nm in the latter case.

Both spectrographs were equipped with an Intensified Charge-Coupled Device (ICCD) camera as a detector. The acquisition of spectra was delayed after the laser ablation pulse, and the delay time was varied to maximize intensity of molecular emission while minimizing emission from atoms and atomic ions. The data reported below represent measurements of spectra from a single or accumulated multiple laser pulses. All measurements were performed in air at atmospheric pressure.

Strontium carbonate and strontium halide powders were obtained from commercial sources, then mixed with 10% paraffin as a binder and pressed by a 7 ton press into one-centimeter diameter pellets. SrCO₃ powder (98% chemical purity) with natural isotopic abundance was obtained from Sigma-Aldrich Corporation. Isotope-enriched powders of ⁸⁸SrCO₃ (99.75% enriched in ⁸⁸Sr) and ⁸⁶SrCO₃ (96.3% enriched in ⁸⁶Sr) were obtained from Cambridge Isotope Laboratories, Inc. Other SrCO₃ powders included NIST Standard Reference Material (SRM 987) with the certified values of the atomic isotope fractions in percent: ⁸⁸Sr=82.5845±0.0066; ⁸⁷Sr=7.0015±0.0026; ⁸⁶Sr=9.8566±0.0034; and ⁸⁴Sr=0.5574±0.0015³⁵. The values of the Sr isotopic percentage were used in this work for proportional subtraction of the SrO spectra.

In addition to SrCO₃, several strontium halides were utilized in this study to demonstrate that molecular spectra of different diatomic radicals can be used for isotopic analysis. Strontium halide powders of natural isotopic abundance included SrF₂ (Sigma-Aldrich, 98% purity), SrCl₂ (Alfa Aesar, 99.5% purity), SrBr₂ (Strem Chemicals, 99% purity), and SrI₂ (Alfa Aesar, 99.99% purity).

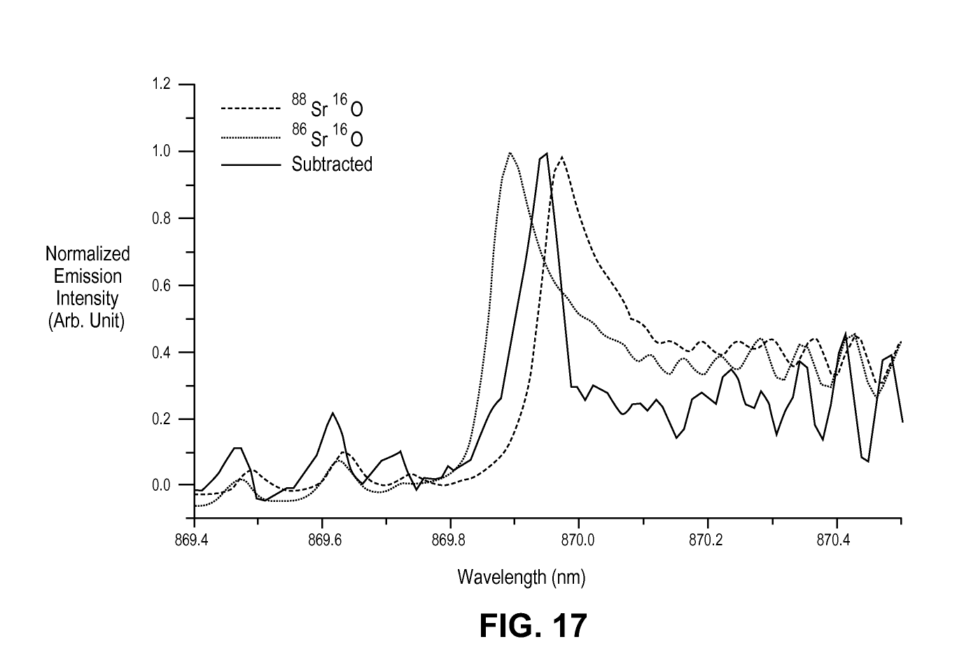

The isotope-enriched samples of ⁸⁸SrCO₃ (99.75% enriched) and ⁸⁶SrCO₃ (96.3% enriched) were ablated to generate spectra of ⁸⁸SrO and ⁸⁶SrO, respectively. The NIST isotopic standard SRM-987 was used to provide the summed spectra from all naturally occurring Sr isotopes with the certified atomic isotope percentages of ⁸⁸Sr=82.58%, ⁸⁷Sr=7.0%, ⁸⁶Sr=9.86%, and ⁸⁴Sr=0.56%. The spectra in FIG. 17 show unique and well resolved spectral signatures of ⁸⁸SrO and ⁸⁶SrO. The isotopic shifts of approximately 0.08 nm and 0.15 nm in the band heads of the (1,0) and (2,0) bands were determined from the measured data. These values agree well with the calculated isotopic shifts in the band origins of the SrO molecules.

The results of numerical subtraction of the isotope-enriched ⁸⁸SrO and ⁸⁶SrO spectra from the SrO spectrum of NIST SRM-987 sample of natural abundance are displayed in FIG. 17 for the (2,0) and (1,0) bands of the A ¹Σ⁺→X ¹Σ⁺ system, respectively. The strontium atomic isotope fractions certified for the SRM-987 sample were used as weight factors for this subtraction. The residual is the spectral contribution from ⁸⁷SrO for the most part. Thus, the spectra of the three radicals ⁸⁸SrO, ⁸⁷SrO, and ⁸⁶SrO were resolved. A rough estimation of the detection limit of some embodiments disclosed herein is below 1% for ⁸⁷Sr.

### Example 6

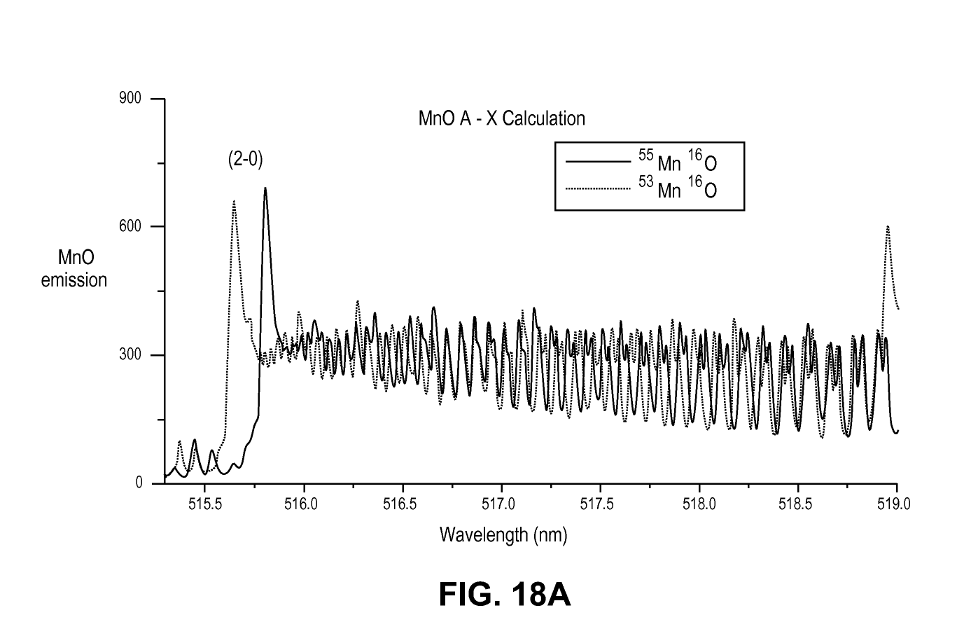

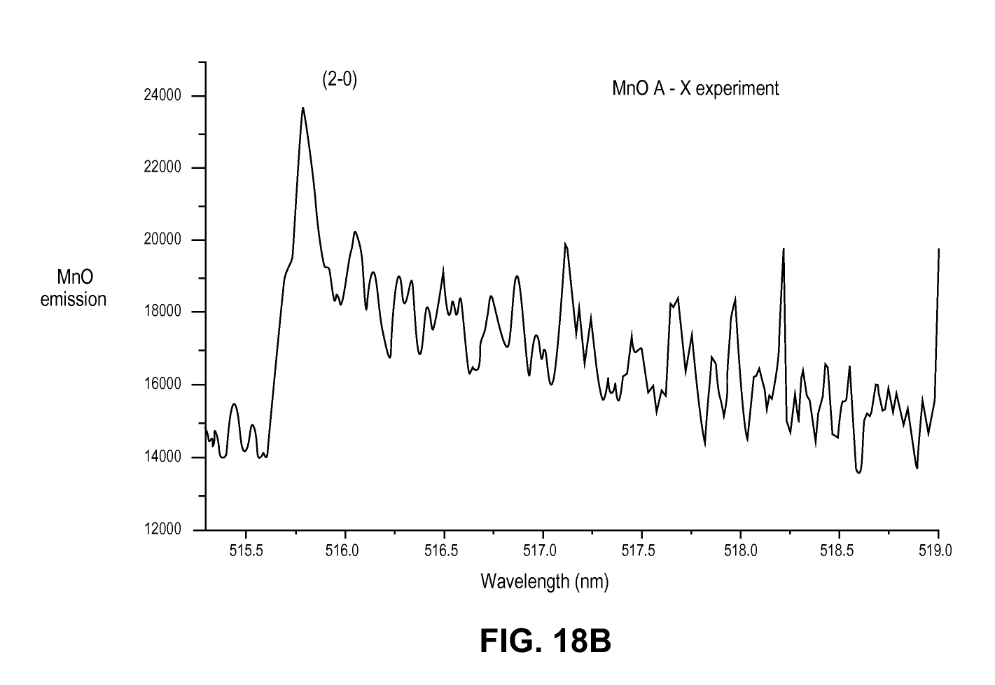

In another experiment, analyses were performed on samples of MnO. FIG. 18A shows calculations of ⁵³MnO and ⁵⁵MnO spectra. FIG. 18B shows experimental values of ⁵⁵MnO as detected in the experiment.

### Example 7

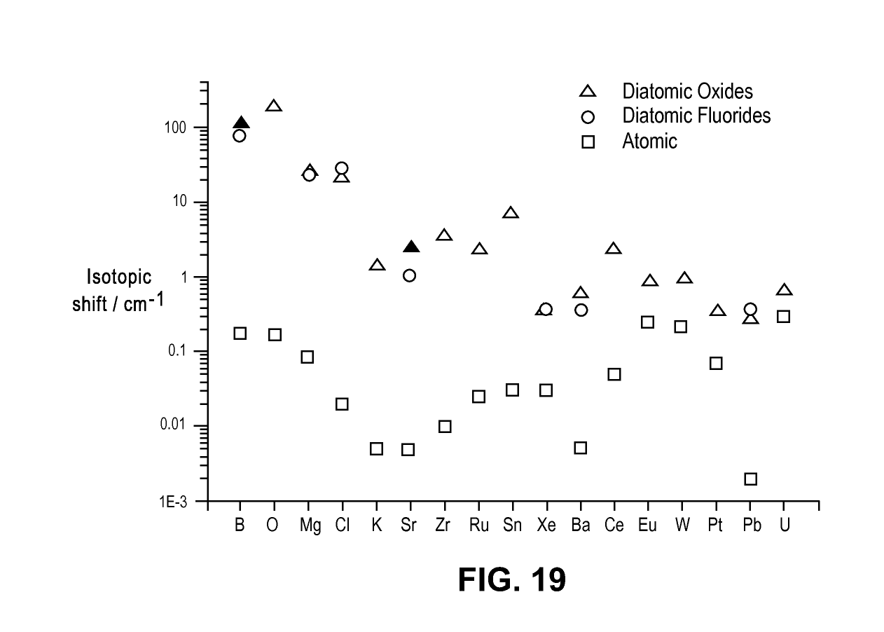

Isotopic shifts can be orders of magnitude larger in molecular than atomic spectra^{23-27,36}, as shown in FIG. 19. Atomic isotope shifts depend on the transition³⁷. The data in FIG. 19 represent prominent lines used in emission spectroscopy.

The effect of mass difference between isotopes is primarily observed in terms Gᵥ (vibrational energy) and F_{J} (rotational energy) of vibronic transitions, while for the electronic component Tₑ (electronic energy), the mass effect is significantly smaller. Consequently, molecular transitions involving change of vibrational and rotational states can exhibit significantly larger isotopic shifts than atomic transitions which are purely electronic in nature, as shown in FIG. 19. Larger isotopic shifts significantly simplify measurement requirements. Isotope ratio measurements from molecular spectra are particularly advantageous for light elements, as shown in FIG. 19. Light elements are important for biological organic life sciences. For heavy elements, the molecular isotopic effect is smaller because it scales with the reduced mass of the formed molecules. Moreover, the vibrational and rotational lines in heavy molecules are closer than in light molecules. FIG. 19 shows molecular vs. atomic isotopic shifts for various elements, where molecular shifts were calculated for either the diatomic oxide for each element considered in this plot and atomic isotopic shift values were taken from Stern et al. As shown in FIG. 19, isotopic shifts are much larger, up to several orders of magnitude, for molecular species as opposed to atomic species. The solid triangles in FIG. 19 denote experimental measurement data.

### CONCLUSION

It is to be understood that the above description and examples are intended to be illustrative and not restrictive. Many embodiments will be apparent to those of skill in the art upon reading the above description and examples. The scope of the embodiments should, therefore, be determined not with reference to the above description and examples, but should instead be determined with reference to the appended claims, along with the full scope of equivalents to which such claims are entitled. The disclosures of all articles and references, including patent applications and publications, are incorporated herein by reference.

### REFERENCES

1. A. K. Carlson “Lead Isotope Analysis of Human Bone for Addressing Cultural Affinity: a Case Study from Rocky Mountain House”, Alberta Journal of Archaeological Science (1996) 23, 557-567.
2. L. Pillonel, R. Badertscher, P. Froidevaux, G. Haberhauer, S. Holzl, P. Horn, “Stable isotope ratios, major, trace and radioactive elements in emmental cheeses of different origins”, Lebensmittel-Wissenschaft und-Technologie—Food Science and Technology, (2003), 36(6), 615-623
3. T. C. Schmidt, L. Zwank, M. Elsner, M. Berg, R. U. Meckenstock, and S. B. Haderlein “Compound-specific stable isotope analysis of organic contaminants in natural environments: a critical review of the state of the art, prospects, and future challenges”, Anal Bioanal Chem (2004), 378, 283-300
4. A. Rossmann, F. Reniero, I. Moussa, H. L. Schmidt, G. Versini, and M. H. Merle, “Stable oxygen isotope content of water of EU data-bank wines from Italy, France and Germany”, Zeitschrift fur Lebensmittel-Untersuchung und-Forschung A—Food Research and Technology, (1999), 208(5-6), 400-407
5. H. P. Balling, and A. Rossmann “Countering fraud via isotope analysis—Case report”, Kriminalistik (2004), 58(1), 44-47
6. A. Moreda-Pineiro, A. Marcos, A. Fisher, and S. J. Hill “Evaluation of the effect of data pre-treatment procedures on classical pattern recognition and principal components analysis: A case study for the geographical classification of tea”, Journal of Environmental Monitoring (2001), 3(4), 352-360
7. A. Moreda-Pineiro, A. Fisher, and S. J. Hill “The classification of tea according to region of origin using pattern recognition techniques and trace metal data”, Journal of Food Composition and Analysis (2003), 16(2), 195-211
8. W. A. Simpkins, G. Patel, M. Harrison, and D. Goldberg “Stable carbon isotope ratio analysis of Australian orange juices”, Food Chemistry (2000), 70(3), 385-390
9. H. Oda, A. Kawasaki, and T. Hirata “Determining the rice provenance using binary isotope signatures along with cadmium content” Proceedings of the 17th World Congress of soil science, (2002) 14th to 21st August, Thailand, symposium no. 59 2002 (pp. 2018-1 to 2018-10).
10. A. Kawasaki, H. Oda, and T. Hirata “Determination of strontium isotope ratio of brown rice for estimating its provenance”, Soil Science and Plant Nutrition (2002), 48(5), 635-640
11. M. Barbaste, L. Halicz, A. Galy, B. Medina, H. Emteborg, and F. C. Adams “Evaluation of the accuracy of the determination of lead isotope ratios in wine by ICP MS using quadrupole, multicollector magnetic sector and time-of-flight analyzers”, Talanta (2001), 54(2), 307-317
12. V. Krivan, P. Barth, and A. F. Morales “Multielement analysis of green coffee and its possible use for the determination of origin”, Mikrochimica Acta (1993), 110, 217-236.
13. M. P. Day, B. L. Zhang, and G. J. Martin “The use of traceelement data to complement stable-isotope methods in the characterization of grapemusts”, American Journal of Enology and Viticulture (1994), 45, 79-85
14. S. J. Haswell and A. D. Walmsley “Multivariate data visualisation methods based on multi-elemental analysis of wines and coffees using total reflection X-ray fluorescence analysis”, Journal of Analytical Atomic Spectrometry (1998), 13(2), 131-134
15. B. W. Smith, I. B. Gornushkin, L. A. King and J. D. Winefordner “A laser ablation—atomic fluorescence technique for isotopically selective determination of lithium in solids”, Spectrochimica Acta Part B: Atomic Spectroscopy (1998), 53(6-8), 1131-1138
16. L. A. King, I. B. Gornushkin, D. Pappas, B. W. Smith and J. D. Winefordner, “Rubidium isotope measurements in solid samples by laser ablation-laser atomic absorption spectroscopy”, Spectrochimica Acta Part B: Atomic Spectroscopy (1999), 54(13), 1771-1781
17. B. W. Smith, A. Quentmeier, M. Bolshov and K. Niemax, “Measurement of uranium isotope ratios in solid samples using laser ablation and diode laser-excited atomic fluorescence spectrometry”, Spectrochimica Acta Part B: Atomic Spectroscopy (1999), 54(6), 943-95
18. E. H. Evans, J. A. Day, C. D. Palmerc, and C. M. M. Smith, “Atomic Spectrometry Update. Advances in atomic spectrometry and related techniques”, Journal of Analytical Atomic Spectrometry (2009), 24, 711-733
19. H. Niki, S. Kataoka, And I. Kitazima, “Laser Breakdown Spectroscopy of BO Molecule”, Journal Of Nuclear Science And Technology (1998), 35(1), 34-39
20. F. MBlen, I. Dubois and H. Bredohl, “The A-X and B-X transitions of BO”, J. Phys. B: At. Mol. Phys. (1985), 18, 2423-2432
21. J. G. Phillips and S. P. Davis, “The singlet Pi-singlet Sigma system of zirconium oxide”, Astrophysical Journal Supplement Series (1976), 32, 537-581
22. P. Mauchien, W. Pietsch, A. Petit, and A. Briand, “Isotopic analysis process by optical emission spectrometry on laser-produced plasma”, US Patent Office, U.S. Pat. No. 5,627,641, Issue date: May 6, 1997
23. N. A. Zakorina, G. S. Lazeeva, A. A. Petrov, Spectroscopic determination of the isotopic composition of boron trifluoride, Atomnaya Energiya, Vol. 20, p. 348-351 (1966). English translation: J. Nucl. Energy, Vol. 21, p. 309-313, (1967).
24. N. A. Zakorina, A. A. Petrov, Isotopic spectral analysis of oxygen in a hot hollow cathode, J. Appl. Spectrosc., Vol. 23, p. 1157-1160 (1975).
25. G. S. Lazeeva, A. A. Petrov, R. V. Khomyakov, Spectral-isotope method for determining carbon in biological objects, J. Appl. Spectrosc., Vol. 25, p. 1199-1205 (1976).
26. G. S. Lazeeva, V. M. Nemets, A. A. Petrov, Spectral-isotopic method of determination of gas-forming elements in organic and inorganic substances, Spectrochim. Acta Part B, Vol. 36, p. 1233-1242 (1981).
27. V. M. Nemets, I. A. Rodushkin, A. A. Solov'ev, V. N. Funtov, Isotopic carbon analysis using the C2 molecule spectrum, J. Appl. Spectrosc., Vol. 52, p. 461-465 (1990).
28. R. E. Russo, A. A. Bol'shakov, X. Mao, C. P. McKay, D. L. Perry, O. Sorkhabi, Laser Ablation Molecular Isotopic Spectrometry, Spectrochim. Acta Part B, 66, 99-104 (2011).
29. J. L. Gottfried, F. C. De Lucia, C. A. Munson, A. W. Miziolek, Double-pulse standoff laser-induced breakdown spectroscopy for versatile hazardous materials detection, Spectrochim. Acta, Part B, 62, (2007) 1405-1411.
30. J. González, C. Liu, J. Yoo, X. Mao, R. E. Russo, Double-pulse laser ablation inductively coupled plasma mass spectrometry, Spectrochim. Acta Part B, 60 (2005) 27-31. Y.-K. Xiao, E. S. Beary, J. D. Fassett, An improved method for the high-precision isotopic measurement of boron by thermal ionization mass spectrometry, Int. J. Mass Spectrom. Ion Process., 85 (1988) 203-213.
32. L. Mercadier, J. Hermann, C. Grisolia, A. Semerok, Plume segregation observed in hydrogen and deuterium containing plasmas produced by laser ablation of carbon fiber tiles from a fusion reactor, Spectrochim. Acta, Part B 65, 715-720 (2010).
33. D. Vukanovic and V. Vukanovic, “On the behaviour of hydrogen isotopes in a d.c. arc plasma”, Spectrochimica acta, 24B, 579-583 (1969).
34. L. St-Onge, R. Sing, S. Béchard, M. Sabsabi, Appl. Phys. A 69, Suppl. 1, S913-S916 (1999).
35. L. J. Moore, T. J. Murphy, I. L. Barnes, P. J. Paulsen, Absolute isotopic abundance ratios and atomic weight of a reference sample of strontium, J. of Res. (NBS) 87 (1982) 1-8.
36. H. Niki, T. Yasuda, I. Kitazima, J. Nuclear Sci. Technol., 35, 34-39 (1998). 1. I. T. Platzner, K. Habfast, A. J. Walder, A. Goetz., Modern isotope ratio mass spectrometry. Wiley, London, 1997, 514 p.
37. R. C. Stern and B. B. Snavely, “The Laser Isotope Separation Program at Lawrence Livermore Laboratory”, Annals of the New York Academy of Sciences 267, 71-79 (1976).

What is claimed is:

1. A method comprising:
(a) applying laser energy to a region of a sample with a laser to generate a plasma; and
(b) recording a spectrum generated by a plurality of molecular species in the plasma with a device.

2. The method of claim 1, wherein the sample is in a solid phase, a liquid phase, or a gas phase.

3. The method of claim 1, further comprising:
after operation (a), allowing the plasma to react with species in the surrounding environment to form the plurality of molecular species.

4. The method of claim 1, wherein operation (a) includes a process selected from the group consisting of ablating the sample with the applied laser energy, vaporizing the sample with the applied laser energy, desorbing the sample with the applied laser energy, and applying the laser energy in a pulse of the laser energy.

5. The method of claim 1, wherein operation (a) includes applying a first pulse of laser energy at a first angle with respect to the sample and applying a second pulse of laser energy at a second angle with respect to the first angle.

6. The method of claim 1, wherein operation (b) is selected from the group consisting of recording the spectrum with visible spectroscopy, recording the spectrum with ultraviolet spectroscopy, recording the spectrum with infrared spectroscopy, recording the spectrum with near-infrared spectroscopy, recording direct optical emission of the plurality of molecular species, recording optical absorption of the plurality of molecular species, recording induced fluorescence of the plurality of molecular species, recording Raman scattering of the plurality of molecular species, recording luminescence of the plurality of molecular species, recording phosphorescence of the plurality of molecular species, recording photoacoustics of the plurality of molecular species, and recording photoionization of the plurality of molecular species.

7. The method of claim 1 further comprising:
(c) quantifying the abundance of isotopes of an element in the sample.

8. The method of claim 7, further comprising:
performing operations (a), (b), and (c) on an additional region of the sample.

9. The method of claim 7, wherein operation (c) includes:
generating a simulated spectrum for each of the plurality of molecular species with a mathematical model;
performing a numerical fitting of the simulated spectrum of each of the plurality of molecular species to the recorded spectrum; and
determining the abundance of the isotopes of the element in the sample from the result of the numerical fitting.

10. The method of claim 1, wherein a specific period of time between operations (a) and (b) increases the intensity of the spectrum generated by the plurality of molecular species in the plasma and decreases the intensity of atomic emission and ionic emission.

11. The method of claim 10, wherein the specific period of time depends on a wavelength of the laser energy, a pulse duration of the laser energy, a power of the laser energy, a spot size of the laser energy, and a fluence of the laser energy.

12. The method of claim 1, wherein operations (a) and (b) are performed in ambient air under ambient pressure.

13. The method of claim 1, wherein operations (a) and (b) are performed in a chamber.

14. The method of claim 1, wherein operations (a) and (b) are performed in a chamber, the chamber containing a specific gas at a specific pressure.

15. The method of claim 1, further comprising:
prior to operation (b), exciting the plasma with an additional energy source.

16. The method of claim 15, wherein the additional energy source is selected from the group consisting of a microwave field, a radio frequency field, and additional laser energy.

17. The method of claim 1, wherein the plurality of molecular species is selected from the group consisting of oxides, nitrides, halides, excimers, diatoms, and combinations thereof.

18. A method comprising:
(a) applying laser energy to a sample in a first chamber with a laser to generate a first plasma that reacts to form species;
(b) transferring the species from the first chamber to a second chamber;
(c) imparting energy to the species in the second chamber to form a second plasma; and
(d) recording a spectrum generated by a plurality of molecular species in the second plasma in the second chamber with a device.

19. The method of claim 18, further comprising:
exciting the second plasma with an additional energy source in the second chamber.

20. The method of claim 18, further comprising:
exciting the first plasma with an additional energy source in the first chamber.
